(19) United States
(12) Patent Application Publication
(10) Pub. No.: US 2021/0334121 A1
(43) Pub. Date: Oct. 28, 2021

(54) METHOD TO CREATE AND RUN PROGRAM IN COMPUTER

(71) Applicant: GuangZhou University, Guangdong (CN)

(72) Inventors: Tianle ZHANG, Guangzhou (CN); Zhihong TIAN, Guangzhou (CN); Lihua YIN, Guangzhou (CN); Naqin ZHOU, Guangzhou (CN); Liwen ZHENG, Guangzhou (CN); Yi FENG, Guangzhou (CN); Dailing XIA, Guangzhou (CN)

(21) Appl. No.: 17/216,796

(22) Filed: Mar. 30, 2021

(30) Foreign Application Priority Data
Apr. 27, 2020 (CN) 202010344777.5

(51) Int. Cl. G06F 9/455; G06F 3/023; G06F 3/02

(52) U.S. Cl. CPC G06F 9/45512; G06F 3/0231; G06F 3/0227; G06F 3/0238

(57) ABSTRACT

A method to create and run a program in a computer including includes: connecting a preset USB-HID device to a computer, wherein the USB-HID device is provided with a first storage area, stores working codes in the first storage area in binary form; the USB-HID device injects a control instruction to the computer, such that the computer creates a text document or opens a command line program according to the control instruction; if the computer creates a text document, the USB-HID device inputs the working codes in the form of keyboard sequence to generate an application corresponding to the working codes, and controls the computer to run the application; and if the computer opens a command line program, the USB-HID device inputs the working codes in the form of keyboard sequence, such that the computer directly runs the working codes through the command line program.

### TECHNICAL FIELD

The present disclosure relates to the technical field of computers, and in particular to a method to create and run a program in a computer.

### BACKGROUND

Human Interface Device (USB-HID) is a type of device that interacts directly with humans, for example, keyboard, mouse, joystick, etc. Common USB-HID devices do not require file systems and have no need to store files, which can directly write data such as characters or codes.

When running software (application) stored in a USB device (USB flash disk) in existing technologies, a user generally connects the USB device to a USB interface of a computer; after the USB device is connected to the computer, a U disk or a virtual drive is generated; then, the user opens the generated U disk or virtual drive to search for the corresponding software and next runs the selected software or program in the computer.

The above scheme has the following problems. 1: The user needs to find and select the corresponding software, install it manually and perform other operations, which is cumbersome. 2: The USB device, especially the U disk, may store various files, and a file system is easy to carry virus programs. The computer will be attacked once a USB device carrying a virus file is inserted, and the security is relatively low.

### SUMMARY

The embodiment of the present disclosure provides a method to create and run a program in a computer, which can automatically generate a program stored in a USB-HID device and run it in a computer, thereby improving the convenience and security of running programs in a computer.

One embodiment of the present disclosure provides a method to create and run a program in a computer, which includes:

Connecting the preset USB-HID device to a computer. Wherein, the USB-HID device is provided with a first storage area, and the first storage area stores working codes, which are stored in the first storage area in binary form.

The USB-HID device injects a control instruction to the computer to create a text document or open a command line program according to the control instruction.

If the computer creates a text document according to the control instruction, the USB-HID device will input the working codes to the text document in the form of keyboard sequence to generate an application corresponding to the working codes, and control the computer to run the application.

If the computer opens a command line program according to the control instruction, the USB-HID device will input the working codes to the command line program in the form of keyboard sequence, such that the computer can run the working codes through the command line program directly.

Further, the USB-HID device inputs the working codes to the text document in the form of keyboard sequence to generate an application corresponding to the working codes, specifically includes:

Inputting the working codes to the text document in the form of keyboard sequence.

Reading a code declaration block in the working codes, and identifying a code type of the working codes.

Modifying a suffix name of the text document according to the code type, and generating an application corresponding to the working codes.

Optionally, the USB-HID device further includes a wireless communication interface for connecting to a wireless communication module, and the USB-HID device is connected to an external communication module through the wireless communication interface.

Optionally, the USB-HID device receives a code modification instruction sent by a mobile control terminal through the external communication module, to perform a modification to the working codes.

Optionally, the USB-HID device further includes a wireless communication module.

Optionally, the USB-HID device receives a code modification instruction sent by a mobile control terminal through the communication module, to perform a modification to the working codes.

Through the implementation of the embodiments of the present disclosure, the following beneficial effects are achieved.

The present embodiment provides a method to create and run a program in a computer. Firstly, a preset USB-HID device with working codes stored is connected to a computer, and the USB-HID device controls the computer to create a document or open a command line program inside the system. If to create a document, the USB-HID device writes the internally stored working codes to the text document in the form of keyboard sequence to generate a corresponding application, and then controls the computer to execute the application; if to open a system command line program, the USB-HID device writes the internally stored working codes to the command line prompt window of the command line program in the form of keyboard sequence, such that the computer directly runs the working codes. Through the above embodiment of the present disclosure, the computer system does not need to allocate a drive letter, and the user does not need to find the application stored in the U disk manually and perform manual installations, thus the convenience of running external applications in a computer is improved; on the other hand, the working codes of the present disclosure are stored in the USB-HID device directly in the form of binary, instead of in the form of file, which avoids common virus and malicious codes caused by file system operation and improves the security.

### BRIEF DESCRIPTION OF THE DRAWINGS

FIG. 1 is a flowchart of a method for creating and running a program in a computer according to one embodiment of the present disclosure.

FIG. 2 is a diagram of a system composed of a USB-HID device and an external mobile terminal according to one embodiment of the present disclosure.

### DETAILED DESCRIPTION

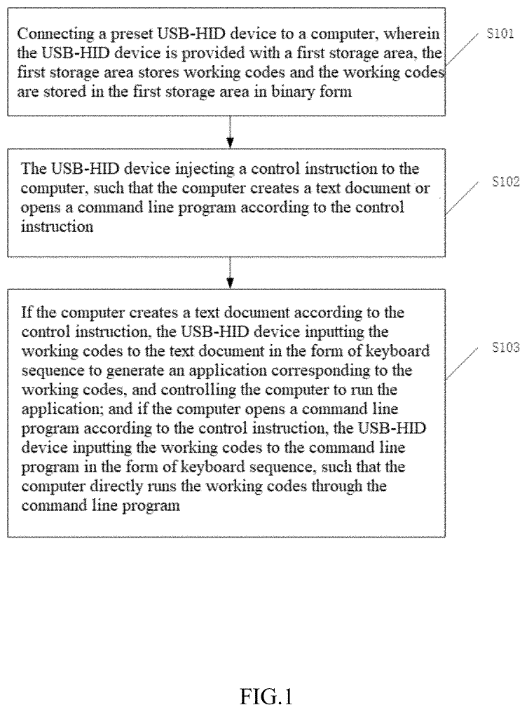

A clear and complete description is provided to the technical scheme in the embodiments of the present disclosure in conjunction with the drawings in the embodiments of the present disclosure. Obviously, the embodiments described hereinafter are simply part embodiments of the present disclosure, rather than all the embodiments. All other embodiments obtained by those skilled in the art based on the embodiments in the present disclosure without creative work are intended to be included in the scope of protection of the present disclosure. As shown in FIG. 1, one embodiment of the present disclosure provides a method for creating and running a program in a computer, which specifically includes the following steps.

S101: connecting the preset USB-HID device to a computer. Wherein, the USB-HID device is provided with a first storage area, and the first storage area stores working codes, which are stored in the first storage area in binary form.

S102: the USB-HID device injects a control instruction to the computer, such that the computer creates a text document or opens a command line program according to the control instruction.

S103: if the computer creates a text document according to the control instruction, the USB-HID device inputs the working codes to the text document in the form of keyboard sequence to generate an application corresponding to the working codes, and controls the computer to run the application; if the computer opens a command line program according to the control instruction, the USB-HID device inputs the working codes to the command line program in the form of keyboard sequence, such that the computer directly runs the working codes through the command line program.

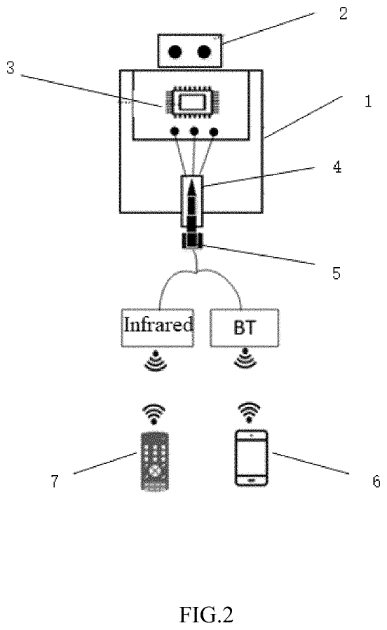

For S101, first, the USB-HID device 1 is explained; in one optional embodiment, as shown in FIG. 2, the USB-HID device 1 includes a USB plug 2, a controller 3 and a wireless communication interface 4; the wireless communication interface 4 may be connected to an external communication module. The wireless communication interface includes but not limited to Bluetooth interface, WiFi interface, infrared IR interface. Through Piggybacking an external communication module via the wireless communication interface, data interaction is achieved between the USB-HID device and an external mobile control terminal. For example, the wireless communication interface may be an earphone jack, which can be connected to an external communication module provided with an earphone plug 5.

Of course, in another optional embodiment, a wireless communication module may be directly integrated in the USB-HID device, to achieve data interaction between the USB-HID device and an external mobile control terminal.

The above external mobile control terminal may be a mobile phone 6 or an infrared remote controller 7.

The USB-HID device is also provided with a memory (not shown), the memory may be an EEPROM memory, and in the memory is reserved a first storage area that stores working codes, the first storage area is a dedicated readable and writable storage area that only the Onboard board card can access, and the working codes are directly stored in the form of binary, instead of in the form of file, to avoid problems of common virus, malicious codes and information leakage caused by file system operation. A user can write the working codes the USB-HID device needs to execute into the first storage area. It should be noted that in the working codes there is a code declaration block used for identifying a type of the working codes. The type of the working codes includes codes and data, specifically including batch (bat) command, script, program code, character string text, data or CLI command, etc.

In addition, a control program is wrote to or reserved in the USB-HID device; when the USB-HID device is inserted into a computer, the control program is used for controlling the USB-HID device to inject a control instruction to the computer, to inject working codes to the computer, to read the working codes in the working codes area, to generate a program corresponding to the working codes in the computer, to control the computer to run the application, and the like. The control program may be burnt to the USB-HID device in advance; the USB-HID device is kept in the form of firmware, such that the USB-HID device has a series of control functions.

The above computer may be a computer installed with the Windows system.

The USB-HID device is connected to a computer through a USB plug thereon.

For S102, the control program inside the USB-HID device controls the USB-HID device to inject a control instruction to the computer, the above control instruction may be composed of a plurality of keyboard sequences, and, after receiving the control instruction, the computer creates a text document or opens a command line program inside the Windows system.

For example, if one control instruction includes a combination of three keyboard sequences: “Win+R”, “cmd” “Enter”; when the computer receives this keyboard sequence combination, the computer will open a command line program to show a DOS command line window on the display interface; if one control instruction is a combination of “notepad d: \a .bat” “Enter”, the computer will create a text document on the display interface.

For S103, there are two conditions.

1. If the computer creates a text document according to the control instruction, the control program inside the USB-HID device controls the USB-HID device to input the stored working codes to the text document in the form of keyboard sequence to generate a corresponding application, and then controls the computer to run the application, thereby completing the task of creating and running a program in the computer.

Preferably, generating an application corresponding to the working codes specifically includes: inputting the working codes to the text document in the form of keyboard sequence; reading a code declaration block in the working codes, and identifying a code type of the working codes; and according to the code type, modifying a suffix name of the text document, and generating an application corresponding to the working codes.

The control program inside the USB-HID device controls the USB-HID device to input the working codes to the text document, to read a code declaration block of the working codes, to identify a code type of the working codes, and then to modify a suffix name of the text document to obtain an application corresponding to the working codes.

2. If the computer opens a command line program according to the control instruction, the control program in the USB-HID device controls the USB-HID device to input the working codes to the command line prompt window directly in the form of keyboard sequence, such that the computer directly runs the working codes through the command line program, thereby realizing the task of creating and running a program in the computer.

In one preferred embodiment, the working codes can be modified through an external mobile control terminal.

Preferably, when the USB-HID device has a wireless communication interface, the wireless communication interface of the USB-HID device is connected to an external communication module; then the USB-HID device receives a code modification instruction sent by a mobile control terminal through the external communication module, to perform a modification to the working codes. It is possible to configure key parameters of the working codes (for example, source and destination paths of file Copy command), modify the content of the working codes or refresh and replace the whole working codes, through a mobile control terminal, for example, mobile phone. After the configuration and maintenance of the working codes in the ROM area is completed, the device may automatically read and generate the control program content, automatically create a corresponding executable program and set up a corresponding running environment in the computer, automatically input the command content and save it, and automatically run the program, thereby completing the control of computer functions.

In another preferred embodiment, when a wireless communication module is provided inside the USB-HID device, the USB-HID device directly receives a code modification instruction sent by a mobile control terminal, to perform a modification to the working codes.

The above communication module includes but not limited to WIFI, infrared or Bluetooth, etc.

To better illustrate the above embodiment, several specific application scenarios are described below.

Application scenario 1:

A user needs to copy a document in the path D: \123.txt in a computer to one U disk. What described below is one step of performing this process.

Preparation stage:

1. The user employs the “bat” command to declare the type of the working codes and write it into the declaration block of the working codes area.

2. The user selects the type of operation function and operation parameters, f such as the function of copying files, and the parameters are: source and destination file paths and file name, etc. Then the USB-HID device will automatically generate working codes in the working codes area (first storage area); which are used for performing the operation of transferring the file in the computer to the U disk, for example: “copy D: \123.txt H:\”.

3. When the user inserts the USB-HID device into the computer, the control program controls the USB-HID device to automatically read the working codes, and the control program automatically creates a file, inputs the working codes, saves as an executable program, and controls the computer to call and execute the program.

Usage state:

1. A new U disk to which a copied file is to be wrote into is inserted to the computer.

2. The user inserts the USB-HID device into the computer.

3. The control program in the USB-HID device starts running automatically.

4. The USB-HID device controls the computer desktop (or the user configures a specified available path) to create a text document and inputs a keyboard sequence “Win+R” to the computer automatically through the control program, which calls the windows system Run interface, and inputs a keyboard sequence “notepad. exe d: \a. bat” to the computer automatically.

5. The USB-HID device inputs the working codes “copy D: \123.txt H: \” to the text document, such as a .bat, and then saves and closes the file.

6. The USB-HID device reads the code declaration block of the working codes area and identifies the type of the working codes through the control program.

7. The USB-HID device modifies a suffix name of the text document to “bat” according to the type of the working codes, which means generating an application corresponding to the working codes.

8. The USB-HID device controls the computer to call and run the .bat application; then, it can be seen that the program automatically executes the copy task. For example, the USB-HID device automatically inputs a keyboard sequence “Win+R” to the computer through the control program, which calls the windows system Run interface, and automatically inputs a keyboard sequence “d: \a. bat” to the computer.

9. Subsequently, the USB-HID device will be set to stop creating program, and simply run the call program mode. Inserting different U disks repeatedly will automatically call the .bat program to complete the copy work and only the USB-HID device is required each time. Repeating this process to bulk can import the computer file to multiple U disks.

The above application scenario can also be implemented in another way.

1. A new U disk to which a copied file is to be wrote into is inserted to the computer.

2. The user inserts the USB-HID device into the computer.

3. The control program in the USB-HID device starts running automatically.

4. The USB-HID device automatically inputs a keyboard sequence “Win+R” to the computer through the control program, which calls the windows system Run interface.

5. The USB-HID device automatically inputs a keyboard sequence “cmd” to the computer through the control program.

6. The USB-HID device automatically inputs a working code keyboard sequence “copy D: \123.txt H: \” to the computer through the control program.

7. It can be seen that the file will be automatically copied to the U disk.

8. Repeating this process to bulk can import the computer file to multiple U disks.

Application scenario 2:

A user needs to automatically turn on the music stored in the path D: \1.mp3. Steps of this process are as follows.

Preparation stage:

1. The user employs the “bat” command, that is, declaring the type of the working codes, and writes it into the declaration block of the working codes area.

2. The user writes working codes in the working codes area of the USB-HID device. The working codes are used for performing the operation of turning on music, for example, “D: \1.mp3” (or input codes: “wmplayer.exe D: \1.mp3”).

3. The user writes a control program in the USB-HID device. When the user inserts the USB-HID device into the computer, the control program will be automatically executed.

Usage stage:

1. The user inserts the USB-HID device into the computer.

2. The control program starts running automatically.

3. The USB-HID device creates a text document on the computer desktop through the control program.

4. The USB-HID device inputs working codes “D: \1.mp3” (or input codes: “wmplayer.exe D: \1.mp3”) to the text document through the control program and then saves it.

5. The USB-HID device reads the code declaration block of the working codes area and identifies the type of the working codes through the control program.

6. The USB-HID device modifies a suffix name of the text document to “bat” according to the type of the working codes, which means generating an application corresponding to the working codes.

7. The USB-HID device controls the computer to call and run the application through the control program. Then, music can be played.

Through implementing the above embodiments of the present disclosure, the computer system does not need to allocate a drive letter, and the user does not need to find the application stored in the U disk manually and perform manual installations, thus the convenience of running external applications in a computer is improved; on the other hand, the working codes of the present disclosure are stored in the USB-HID device directly in the form of binary, instead of in the form of file, which avoids common virus and malicious codes caused by file system operation and improves the security. Moreover, the working codes can be modified through an external control terminal, which realizes the diversification of USB-HID device functions. The above are the preferred implementations of the present disclosure. It should be noted that, for the ordinary staff in this art, multiple improvements and modifications can be made without departing from the principle of the present disclosure, and these improvements and modifications shall fall into the scope of protection of the present disclosure.

1. A method for creating and running a program in a computer comprises:
connecting a preset USB-HID device to the computer, wherein the USB-HID device is provided with a first storage area, and the first storage area stores working codes, which are stored in the first storage area in binary form;
the USB-HID device injects a control instruction to the computer to create a text document or opens a command line program according to the control instruction;
wherein:
if the computer creates a text document according to the control instruction, the USB-HID device inputs the working codes to the text document in the form of a keyboard sequence to generate an application corresponding to the working codes, and controls the computer to run the application; and
if the computer opens a command line program according to the control instruction, the USB-HID device inputs the working codes to the command line program in the form of the keyboard sequence, such that the computer runs the working codes through the command line program.

2. The method for creating and running a program in a computer as described in claim 1, wherein the USB-HID device inputs working codes into a text document in the form of the keyboard sequence to generate an application program corresponding to the working codes, which specifically includes:
inputting the working codes to the text document in the form of the keyboard sequence;
reading a code declaration block in the working codes, and identifying a code type of the working codes; and
modifying a suffix name of the text document according to the code type, and generating an application corresponding to the working codes.

3. The method for creating and running a program in a computer as described in claim 1, wherein the USB-HID device also includes a wireless communication interface for connecting to a wireless communication module, and the USB-HID device is connected to an external communication module through the wireless communication interface.

4. The method for creating and running a program in a computer as described in claim 3, wherein the USB-HID device receives a code modification instruction sent by a mobile control terminal through the external communication module to modify the working code.

5. The method for creating and running a program in a computer as described in claim 1, wherein the USB-HID device also includes a wireless communication module.

6. The method for creating and running a program in a computer as described in claim 5, wherein the USB-HID device receives a code modification instruction sent by a mobile control terminal through the wireless communication module to modify the working codes.
